(19) United States
(12) Patent Application Publication
(10) Pub. No.: US 2022/0151860 A1
(43) Pub. Date: May 19, 2022

(54) WHEELED WALKER WITH ARM RESISTANCE MECHANISM AND METHOD

(71) Applicant: ProtoStar, Inc., a Delaware Corporation, San Diego, CA (US)

(72) Inventors: Craig Timothy Shugert, Rancho Santa Fe, CA (US); Peter James Fellingham, San Diego, CA (US)

(73) Assignee: ProtoStar, Inc., a Delaware Corporation, San Diego, CA (US)

(21) Appl. No.: 17/102,186

(22) Filed: Nov. 23, 2020

Related U.S. Application Data
(60) Provisional application No. 63/113,712, filed on Nov. 13, 2020.

(51) Int. Cl. A61H 3/04; A63B 23/035; A63B 21/00; A63B 23/12

(52) U.S. Cl. CPC A61H 3/04; A63B 23/03541; A63B 21/4033; A61H 2003/006; A63B 23/12; A61H 2201/0192; A63B 21/4047

(57) ABSTRACT

The described device demonstrates an apparatus and method for a collapsible wheeled walker or rollator that includes a pair of height adjustable armrests or supports. The armrests may be selectively articulated about hinge or pivot attached to a support tube. The articulating armrest may be locked into a stationary position via a locking pin for use as a typical standing rollator. Alternatively, the armrests are articulable about a hinge when the locking pin is removed, where a damper is interconnected between the hinge and a handle tube attached to the armrests to provide resistance to the movement of the armrests allowing a user to exercise arm muscles while using the wheeled walker. As such the disclosed device operates as both a wheeled walker and an exercise mechanism for the user's arms and upper body.

### CROSS-REFERENCE TO RELATED APPLICATIONS

The present application claims the benefit of U.S. Provisional Application No. 63/113,712, filed Nov. 13, 2020, the contents of which are expressly incorporated herein by reference.

### STATEMENT RE: FEDERALLY SPONSORED RESEARCH/DEVELOPMENT

Not Applicable

### BACKGROUND

### Technical Field

The present inventive subject matter generally relates to combined assistive mobility devices and exercise apparatus, and more particularly to a collapsible wheeled walker or rollator with a folding mechanism that includes pair of height adjustable forearm supports that may be articulated about a pivot. A damper provides resistance to the movement of the armrests allowing a user to exercise arm muscles while using the wheeled walker for health benefits.

### Background

Assistive mobility devices, including walkers or rollators, are widely used by mobility impaired individuals. A detailed discussion of the use and classification of mobility assistance devices is discussed in U.S. Pat. No. 9,585,807 to Fellingham, issued on Mar. 7, 2017 and entitled Collapsible Upright Wheeled Walker Apparatus (“Fellingham”), the entire substance of which is incorporated herein by reference as though fully set forth herein.

Many existing wheeled walker and rollator devices were not designed to support significant user weight during use and are used for the accepted purpose of providing assistance in balance and gait. Use of such devices requires the user to engage the walker or rollator with the hands and wrists alone, often with a stooping and leaning posture. Fellingham discloses an apparatus with raised adjustable forearm support elements to provide upper body support to a user allowing the wheeled walker to support a significant amount of a user's weight while the user is walking. Fellingham discloses allowing a user to engage the wheeled walker in an upright walking position supported by the user's forearms and including two forward hand grips. The upright walking posture has the advantages reducing heart and lung compression, improves circulation and providing the therapeutic effects of longer walking times. Other patents and patent publications disclose wheeled walkers supporting upright walking posture with supports for user's upper body or forearms and include U.S. Pat. No. 10,307,321 issued Jun. 4, 2019 entitled Wheeled Walker with Movable Seat to Pan (“Pan”), U.S. Pat. No. 10,617,592 issued Apr. 14, 2020 entitled Wheeled Walker to Fellingham (“Fellingham II”), U.S. Patent Publication No. 2020/0315901 filed Mar. 31, 2020 to Fellingham (“Fellingham III) entitled Collapsible Wheeled Walker With Stability Enhancing Bracket Apparatus and Method, the entire substance of each of the forgoing patents and publication of Pan, Fellingham II, and Fellingham III and are all incorporated herein by reference as though fully set forth herein.

Also, while many of existing wheeled walkers and rollators include the ability for height adjustment of armrests, such armrests on existing wheeled walkers and rollators remain generally in a fixed position stationary during use. Existing wheeled walker and rollators do not provide a further mechanism for additional exercise opportunities using the armrests and handles for exercising the upper body.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### BRIEF SUMMARY

The inventive subject matter described herein demonstrates an apparatus and method for a collapsible wheeled walker or rollator that includes a pair of height adjustable armrests or supports that may be selectively articulated about hinge or pivot. The articulating armrest may be locked into a stationary position via a locking pin, or alternatively articulable about a hinge when the locking pin is removed. A damper is interconnected between the hinge and a handle tube attached to the armrests to provide resistance to the movement of the armrests allowing a user to exercise arm muscles while using the wheeled walker. As such the disclosed device operates as both a wheeled walker and an exercise mechanism for the user's arms and upper body.

The wheeled walker device disclosed herein comprising a first side frame and a second side frame, with each side frame interconnected by an X-folder apparatus that facilitates the collapsing of the wheeled walker into a collapsed configuration for transport and storage, the X-folder component being described in detail in U.S. Pat. No. 10,617,592 to Fellingham issued Apr. 14, 2020 entitled Wheeled Walker (Fellingham II), incorporated by reference. Each side frame comprises an elongate base member attached to forward and rear wheel assemblies. Support members are attached to the base member and extend upwardly from the base member intersecting at a support apex. The support apex on each side frame includes an opening for receiving first and second height adjustment members that may be selectivity adjusted relative to the apex of each side frame. A first forearm support or user support and handle member is pivotably interconnected to the first height adjustment member via a first hinge having a protruding fork member. The first forearm support is rotatable about a pivotal connect from a first position defining a first angle between a longitudinal axis of the first forearm support and the first height adjustment member to at least a second position defining a second angle between the longitudinal axis of the first forearm support and an axis through the first height adjustment member. A second forearm support or user support and handle member is pivotably interconnected to the second height adjustment member via a second hinge having a protruding fork member. The second forearm support is rotatable about a pivotal connection from a first position defining a first angle between a longitudinal axis of the second forearm support and the second height adjustment member to at least a second position defining a second angle between the longitudinal axis of the second forearm support and an axis through the second height adjustment member. A first elongate tube damper interconnects the first handle member and the fork member of the first hinge and a second elongate tube damper interconnects the second handle member and fork member of the second hinge. A locking pin is provided for the first and second hinges, to prevent the hinges from rotating when a locking pin is inserted. When the locking pin is inserted the wheeled walker device operates similarly to the device shown in Fellingham II, that does not provide for articulating handles and forearm rests. However, when the locking pin is removed, the handle and forearm rests are free to rotate about the pivot and may be pushed up along a line of rotation or pulled down along a line of rotation. The tube damper, which is speed sensitive, acts to provide resistance to the user when rotating the handle and forearm rest. The more slowly the handle and forearm rest is moved, the less resistance. The faster the handle and forearm rest are moved the more resistance is provided by the damper. As such, while walking or standing using the disclosed rollator a user may exercise arm muscles by rotating the handles and armrests up and down.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a rear perspective view of the disclosed wheeled walker device;

FIG. 2 is a left side view of the disclosed wheeled walker device;

FIG. 3 is a left side view of the disclosed wheeled walker device with a user shown in broken lines with movement of arm rests;

FIG. 4 is a left side view of the disclosed wheeled walker device with a user shown in broken lines with movement of arm rests;

FIG. 5 is a left side view of the handle and armrest of the disclosed wheeled walker device, demonstrating movement of the handle and armrest about a hinge at a first position;

FIG. 6 is a left side view of the handle and armrest of the disclosed wheeled walker device demonstrating movement of the handle and armrest about a hinge at a second position;

FIG. 7 is an inside view of the right side of the disclosed wheeled walker device showing an exploded view of the hinge assembly, armrest assembly and handle assembly;

FIG. 8 is a top perspective view of an outer view of the right-side armrest assembly of the disclosed wheeled walker device exploded from an exploded view of the hinge assembly;

FIG. 9 is a bottom perspective view of an inner view of the right-side armrest assembly of the disclosed wheeled walker device exploded from an exploded view of the hinge assembly;

FIG. 10 is a top view of the disclosed wheeled walker device;

FIG. 11 is a front view of the disclosed wheeled walker device; and

FIG. 12 is a cross sectional view 12-12 along the lines as shown in FIG. 12 of the disclosed wheeled walker device.

### DETAILED DESCRIPTION

The detailed description set forth below in connection with the appended drawings is intended as a description of certain embodiments of a wheeled walker with articulating exercise support arms with resistance of movement and/or related method and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

The background, summary and the above description includes information that may be useful in understanding the present disclosure. It is not an admission that any of the information provided herein is prior art or relevant to the presently claimed inventive subject matter, or that any publication specifically or implicitly referenced is prior art.

In some embodiments, the numbers expressing dimensions, quantities, quantiles of ingredients, properties of materials, and so forth, used to describe and claim certain embodiments of the disclosure are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the disclosure are approximations, the numerical values set forth in the specific examples are reported as precisely as practicable. The numerical values presented in some embodiments of the disclose may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the disclosure and does not pose a limitation on the scope of the claimed inventive subject matter. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed. Various objects, features, aspects and advantages of the inventive subject matter will become more apparent from the following detailed description of preferred embodiments, along with the accompanying drawing figures in which like numerals represent like components.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

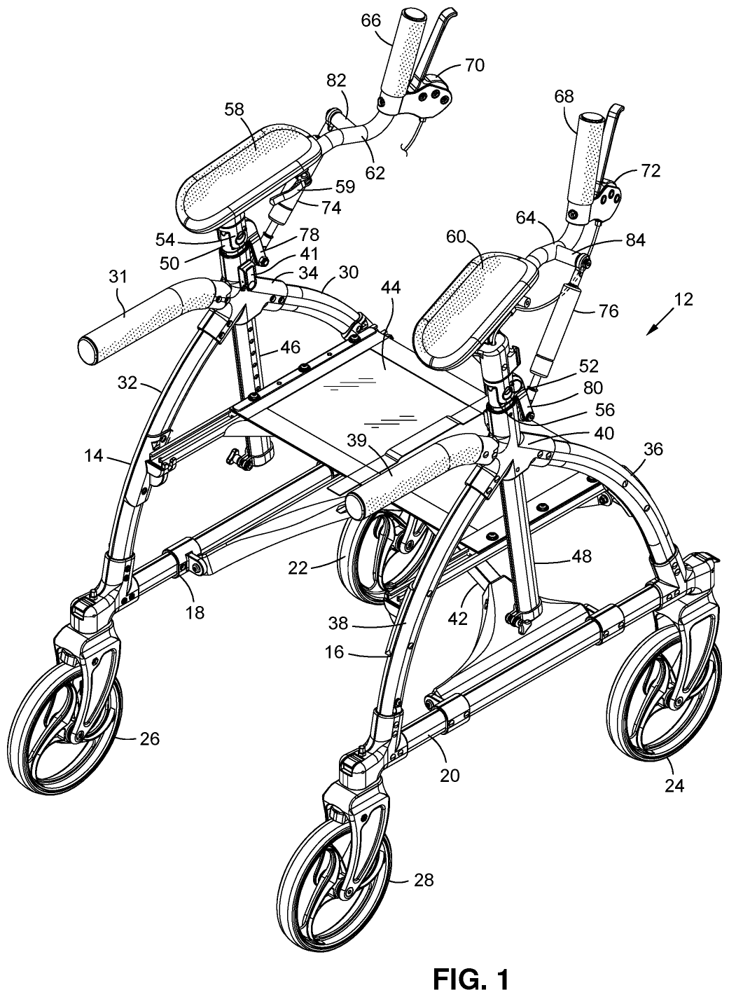

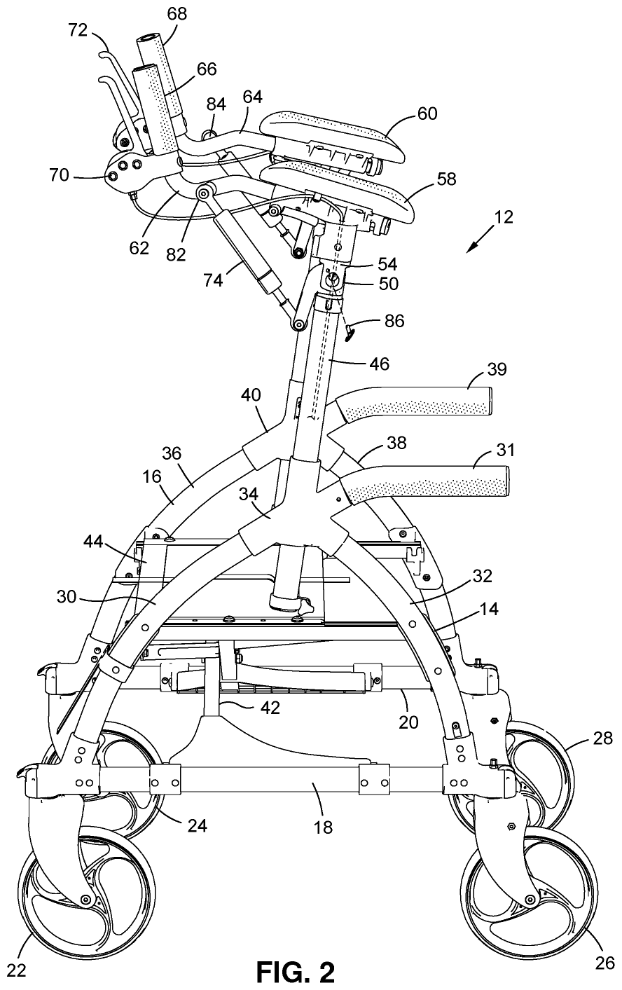

Referring particularly to FIGS. 1 and 2, there is shown the wheeled walker device 12 of the present disclosure. The device 12 includes a first side frame 14 and a second side frame 16. The side frames 14 and 16 include base members 18 and 20 respectively, and base members 18 and 20 have forward wheels 22 and 24 respectively, and rear wheels 26 and 28 respectively. Side frame 14 includes forward upwardly extending support 30 and upwardly extending support 32 and joining at joint 34. Likewise, side frame 16 includes forward upwardly extending support 36 and upwardly extending support 38 and joining at joint 40. Side frames 14 and 16 are interconnected by an X-folder 42. The X-folder apparatus 42 facilitates the collapsing of the wheeled walker into a collapsed configuration for transport and storage. The X-folder apparatus 42 is described in detail in U.S. Pat. No. 10,617,592 to Fellingham issued Apr. 14, 2020 entitled Wheeled Walker (Fellingham II), incorporated herein by reference. In the fully deployed position, a seat 44 is secured between side frames 14 and 16. Joints 34 and 40 include open channels (not shown) to receive height adjustment supports 46 and 48, respectively. In FIG. 1, the height adjustment supports 46 and 48 are set to the lowest position, and in FIG. 2 the height adjustment supports 46 and 48 are set to a higher position. As shown in FIGS. 1, 7, 11 and 12, height adjustment tabs 41 and 43 are provided on the adjustment supports 46 and 48 to release, when pressed in by the user, the supports 46 and 48 to move the supports up and down, and then upon disengagement of the tabs 41 and 43 the supports 46 and 48 are locked into place as described in more detail in Fellingham II. Frame 14 also includes a lower handle member 31 coupled to member 32 and extending longitudinally rearwardly from member 32. Frame 16 also includes a lower handle member 39 coupled to member 38 and extending longitudinally rearwardly from strut 38. Each of the lower handles 31 and 39 are disposed to permit a user to grasp lower handles 31 and 39 and move forward, using walker apparatus 12 for stability and guidance without using the forearm supports 58 and 60, more in line with a non-forearm support walker device. The lower handles 31 and 39 may be additionally useful for a user to pull themselves up from a seated position on seat 44 to engage the walker device 12. Also, the ends of the lower handles 31 and 39 may include reflectors or reflective material to increase visibility of the walker device 12 at night when in use. The aforementioned components of wheeled walker device 12 including the side frames 14 and 16, base members 18 and 20, forward wheels 22 and 24, rear wheels 26 and 28, upward extending support 30, lower handle member 31, upward extending support 32, joint 34, upward extending supports 36 and 38, lower handle member 39, joint 40, height adjustment tab 41, x-folder 42, height adjustment tab 43 and seat 44 are essentially identical and assembled essentially identically to the wheeled walker device U.S. Pat. No. 10,617,592 to Fellingham issued Apr. 14, 2020 entitled Wheeled Walker (Fellingham II), incorporated herein by reference.

A significant difference between the wheeled walker device of Fellingham II are the elements fixed to the top of height adjustment supports 46 and 48. Adjustable supports 46 and 48 are coupled to hinge assemblies 50 and 52, respectively. The hinge assemblies 50 and 52 are coupled to upper forks 54 and 56, respectively. Upper fork 54 is coupled to the left forearm rest 58 and the upper fork 56 is attached to right forearm rest 60. The forearm rests 58 and 60 are coupled to handle support tubes 62 and 64, respectively. The handle support tube 62 is formed to turn upwardly to define a handle 66. Likewise handle support tube 64 is formed to turn upwardly to define handle 68. Handles 66 and 68 are each coupled to hand brake levers 70 and 72. A tube damper 74 is attached between a lower fork 78, pivotally between the fork members of the lower fork 78 and pivotally attached to an attachment member 82 coupled to the handle support tube 62. Likewise, a tube damper 76 is attached between a lower fork 80, pivotally between fork members of the lower fork 80 and pivotally attached to an attachment member 84 coupled to the handle support tube 64. Referring particularly to FIG. 2, there is shown a locking pin 86 exploded from first frame 14.

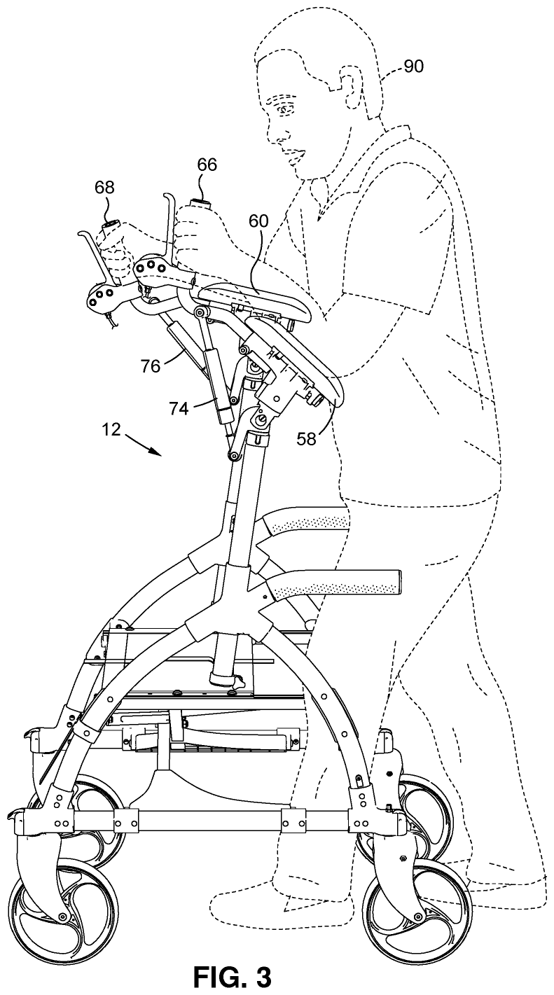

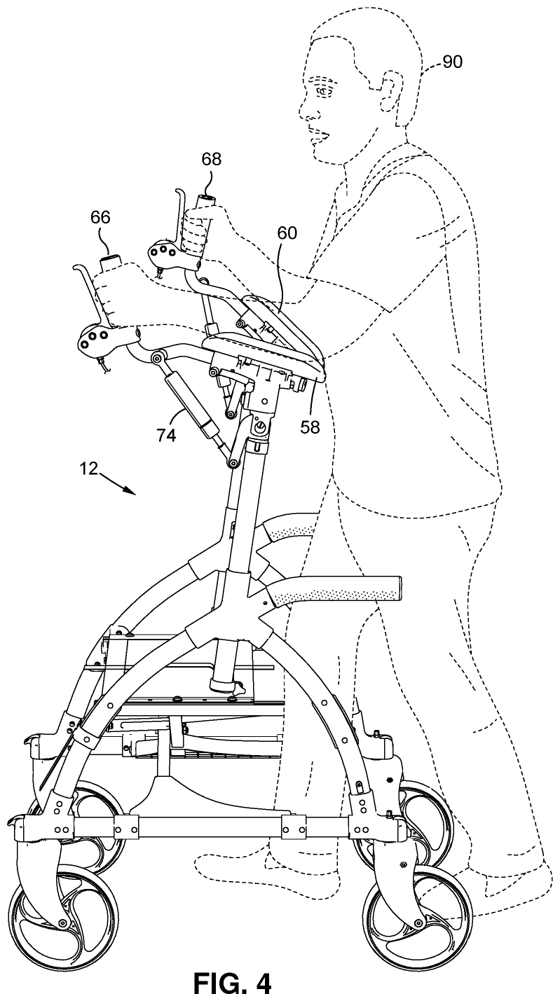

Referring particularly to FIGS. 3 and 4, there is shown the device 12 in use, where the locking pins 86 and 88 have been removed from the hinge assembly to allow the hinge assemblies 50 and 52 to rotate. By allowing rotation of the hinge assemblies 50 and 52 a user 90 grasping handles 66 and 68, places the user's forearms in arm rests 58 and 60, the user 90 can pump the user's arms up and down to create movement of the arm rests 58 and 60, and the dampers 74 and 76 provide resistance against free movement, requiring the user 90 to use greater force to achieve the movement and therefor provide a resistance for the exercise for the arms. The user 90 can exercise arm muscles while walking along with the rollator or standing still. Even when the user 90 is pulling and pushing the handles 66 and 68 to exercise the user's arms, the user maintains contact with the forearm rests 58 and 60 to enable the user 90 to maintain the support and user stability via the wheeled walker 12. It is to be understood and appreciated by the present disclosure that the user 90 shown in FIGS. 3 and 4 may not be to scale relative to the walker device 12 and is provided for exemplary discussion of the use of the device 12.

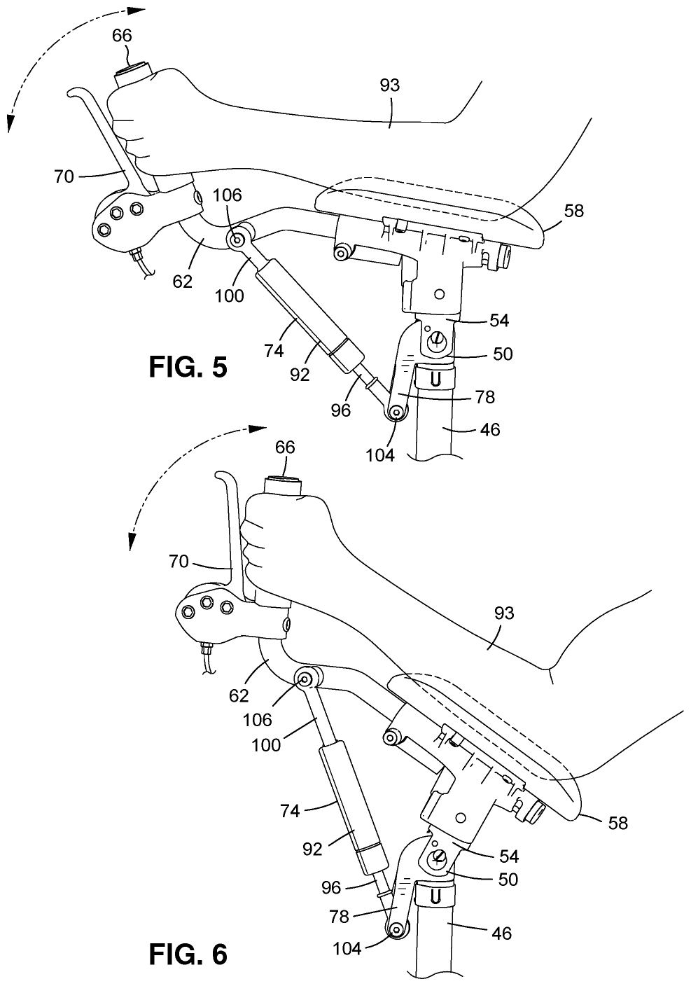

Referring to FIGS. 5 and 6, there is shown the tube damper 74 having an outer tube 92 and rods 96 and 100 and with ball joint ends 104 and 106, respectively. The tube damper 74 may be a twin tube damper and internally may comprise an internal piston (not shown), seals (not shown) and valving components (not shown) as is typical with known dampers. The tube damper 74 provides a mechanism to provide resistance to the rocking or moving of the handle 66 and forearm rest 58. It is contemplated by this disclosure that other known damper types may be used to provide the damping function, including mono-tube dampers, springs or other suitable biasing members. The damper 74 may be speed sensitive, in that the faster the movement, the greater stiffness in the resistance of the damper 74. Importantly, tube damper 74 (as well as tube damper 76) is of a shortened length. The shortened length of the damper 74 allows the damper 74 to be functionally interconnected between the handle support tube 62 and the lower fork 78 of the hinge assembly 50 to facilitate movement of the handle 66 and forearm rest 58. It is contemplated by the present disclosure that the damper 74 may include an adjustment mechanism to adjust the stiffness of the damping. FIGS. 5 and 6 illustrate movement of handle 66 and forearm rest 58 on the left side of the device 12 (the right side operating identically), where the user 90 left arm 93 is received by the forearm rest 58 and with the hand grasping the handle 66 the interconnected elements move about the hinge assembly 52. It is to be understood and appreciated by the present disclosure that the user arm 93 shown in FIGS. 5 and 6 may not be to scale relative to elements of the walker device 12 shown in such figures and is provided for exemplary discussion of the use of the identified elements of device 12.

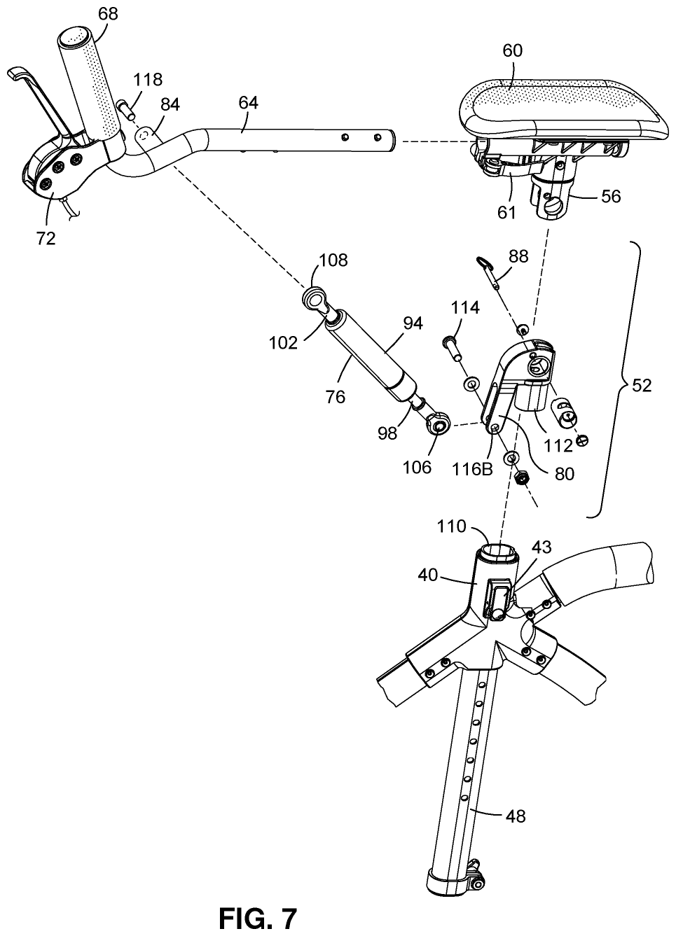

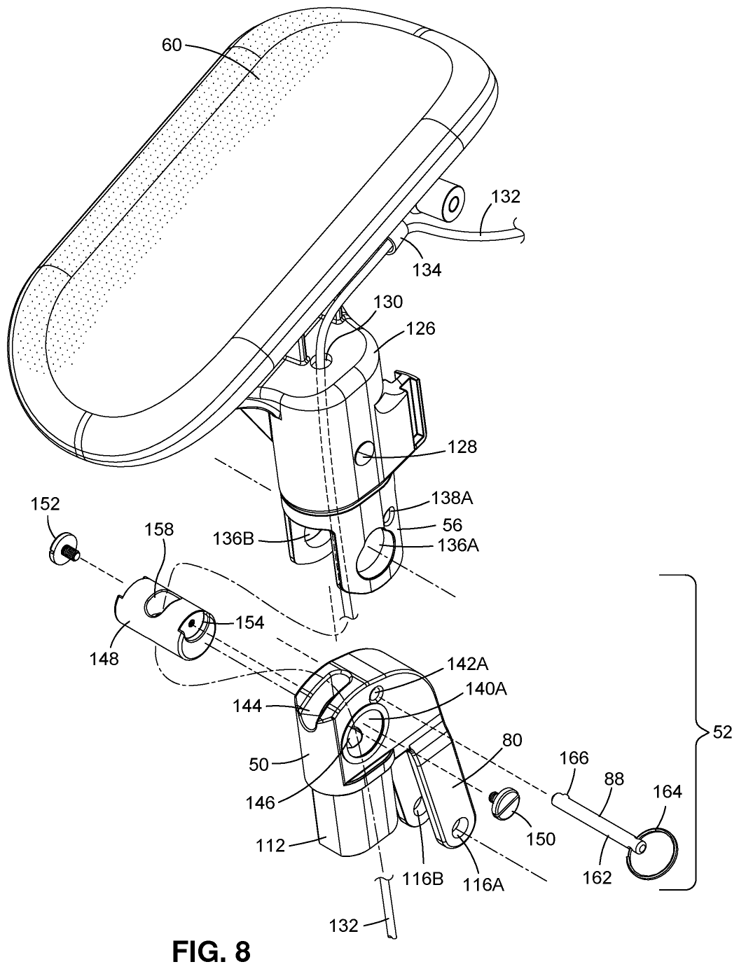

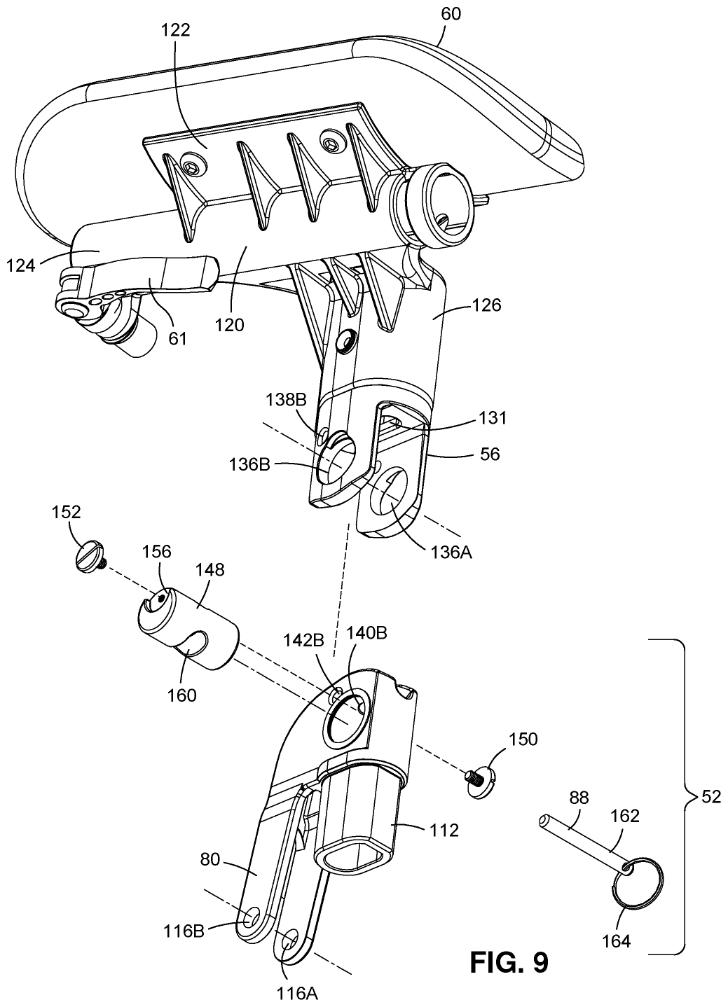

Referring particularly to FIG. 7 there is shown an inside exploded view of the right-side components that attach to the adjustable member 48. As shown, the adjustable member 48 includes an open channel 110 that is adapted to receive the downtube 112 of the hinge assembly 52. The hinge assembly 52 is fixedly attached to the adjustable member 48 via the channel 110 that receives the downtube 112. A lower fork 80 protrudes from the hinge assembly 52 and includes first and second elongate members, each with an opening to receive a fastener through openings 116A and 116B. The fastener 114 is guided into opening 116A of the lower fork 80 of the hinge assembly 52, through an opening in ball joint end 106 of rod 98 of the damper 76 and through opening 116B and secured by a nut or other like mechanism. The fastener 114 acts as a pivot about which the ball joint end 106 may rotate, between the members of the lower fork 80. The opposite end of the damper 76 includes a ball joint 108 having a center opening. A fastener 118 is received through an opening formed in attachment member 84 that is rigidly coupled to the handle support tube 64, and passed through opening in ball joint 108, to provide a pivotal connection between damper 76 and handle support tube 64. As such, damper 76 is pivotally coupled on both ends, at ball joint 108 to the member 84 at the top end and lower fork 80 at ball joint 106 at the lower end. The handle support tube 64 is received into and secured at the base of the forearm support 60. Cam lever 61 is shown that is operable to lock the support tube 64 in place to the base of the forearm support 60, and the release of the cam lever 61 enables rotational movement of the support tube 64 within the base of forearm support 60, resulting in the handle 68 to be angularly oriented according to a user's placement. Cam levers 61 and 59 are shown in FIGS. 1, 7, 9, 11 and 12. Similarly cam lever 59 locks support tube 62 in place to the base of forearm support 58, and the release of the cam lever 59 enables rotational movement of the support tube 62 within the base of forearm support 58, resulting in the handle 66 to be angularly oriented according to a user's placement. The operation of cam levers 59 and 61 is discussed in Fellingham II, although the angular adjustment of handles 66 and 68 in the present disclosure may be more restricted in range of motion than in Fellingham II due to the attachments of the dampers 74 and 76 to handle support tubes 62 and 64, respectively. The base of the forearm support 60 is coupled to a lower fork 56, and the lower fork 56 couples to the hinge assembly 52, described in more detail in FIGS. 8 and 9.

Referring particularly to FIGS. 8 and 9, there is shown a right-side assembly of the forearm rest 60, fork 56 and hinge assembly 52. Note the left side of the device 12 includes identical, but reversed components and construction. The upper component comprises the forearm rest 60 attached to a plastic base 120 that includes a curved upper platform 122 for attaching to the forearm rest 30. The shape of the upper platform 122 conforms to the bottom curved base of the forearm rest 60 and is secured into place via fasteners. The platform 122 is molded to a support tube 124 that is adapted to receive and secure to the handle support tube 64. The base 120 also includes molded down tube 126, that is adapted to receive the upper fork 56 formed of metal. As such the plastic base 120 is a unitary structure comprising the upper platform 122, support tube 124 and down tube 126. A fastener 128 secures the upper fork 56 within the downtube 126. The down tube 126 includes an aperture 130, for receiving a brake cable 132 to thread the cable 132 into the interior of the down tube 126, hinge assembly 52 and then through the adjustable height member 48, to effect a braking mechanism (not shown) attached to the wheels 22, 24, 26 and/or 28. The brake cable 132 may be received into a cylindrical guide 134 for close alignment to the edge of the forearm support 60.

The upper fork 56 includes hinge pin apertures 136A and 136B formed into the downward extending prongs of the upper fork 56. Above each of the hinge pin apertures 136A and 136B there are formed locking pin openings 138A and 138B. The hinge assembly 52 also includes hinge pin apertures 140A and 140B and locking pin apertures 142A and 142B. The hinge assembly also includes an opening 144 to provide a passage for the brake cable 132 and is shaped to work cooperatively with the other components openings to avoid pinching, bending or fatiguing a brake cable 134. The hinge assembly 52 also includes an internal opening 146 to allow the passage of the brake cable 132 into the adjustable support tube 48. In assembly, upper fork 56 is received over the hinge assembly 52 to align the hinge pin apertures 136A-B and hinge pin apertures 140A-B. In alignment, both hinge pin apertures 136A-B and hinge pin apertures 140A-B receive a hinge pin 48 that is secured in place hinge pin retainers 150 and 152. The hinge pin 148 includes recesses 154 and 156 to receive retainers 150 and 154 respectively. The recesses are 154 and 156 are off-set from the center of the hinge pin 148 to keep the hinge pin 148 in a preferred orientation. As such, with the turning of the upper fork 56 about the hinge assembly 52, the hinge pin 148 remains in an orientation that allows openings 158 and 160 to maintain a generally vertical passage through the hinge pin 148 to allow the passage of the brake cable 132 without the cable 132 being bent or otherwise fatigued. The brake cable passage 132 is shown in FIG. 8. The brake cable 132 is guided into position by guide 134, and received into opening 130 through down tube, through an aperture 131 (see FIG. 9) formed in the top of the upper fork 56, into the opening 158, through opening 160 and down through the opening 146 of the hinge assembly 52 into the downtube 112 and into the adjustable support 48. The left side construction of the forearm support 58 works identically in reverse configuration.

When a user wishes to stop the rotation of the armrest 60 about the hinge pin 148, a locking pin 88 is provided to be inserted into openings 138A, 142A, 142B and 138B. The locking pin prevents rotation and freezes the joint comprising the hinge assembly 52 and the upper fork 56 from rotating. The locking pin 88 may be an elongate member 162 having enough length to pass through the hinge assembly 52 and upper fork 56. The locking pin 88 may have a grasping ring 164 formed on the end of the member 162 to allow a user to easily grasp the locking pin 88. A string or chord (not shown) may be attached to the ring 164, which is attached to the part of the device 12 to prevent loss of the locking pin 88. The locking pin 88 may also have a spring-loaded ball 166 formed toward the end of member 162 which is pushed in during insertion through the various apertures, and springs out when the member 162 has passed through the members. Locking pin 86 has identical construction.

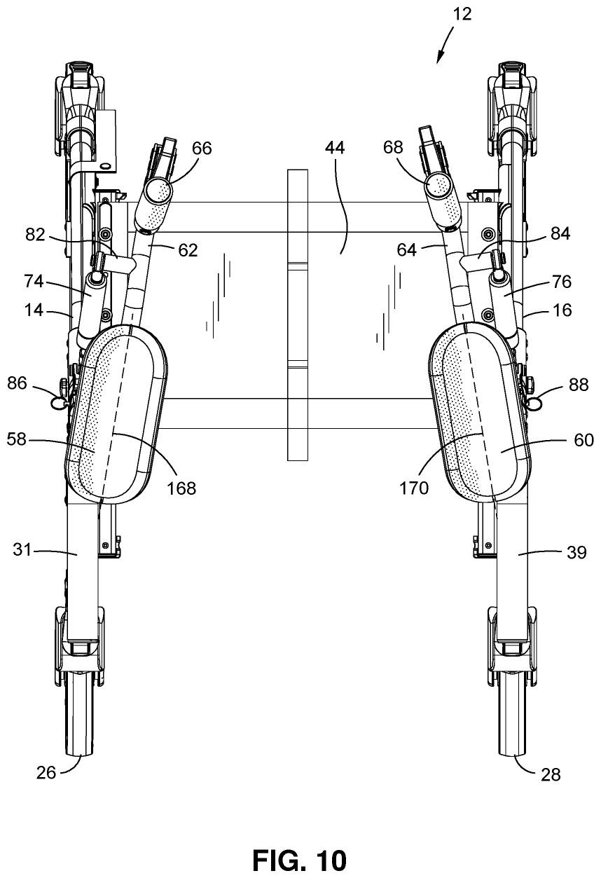

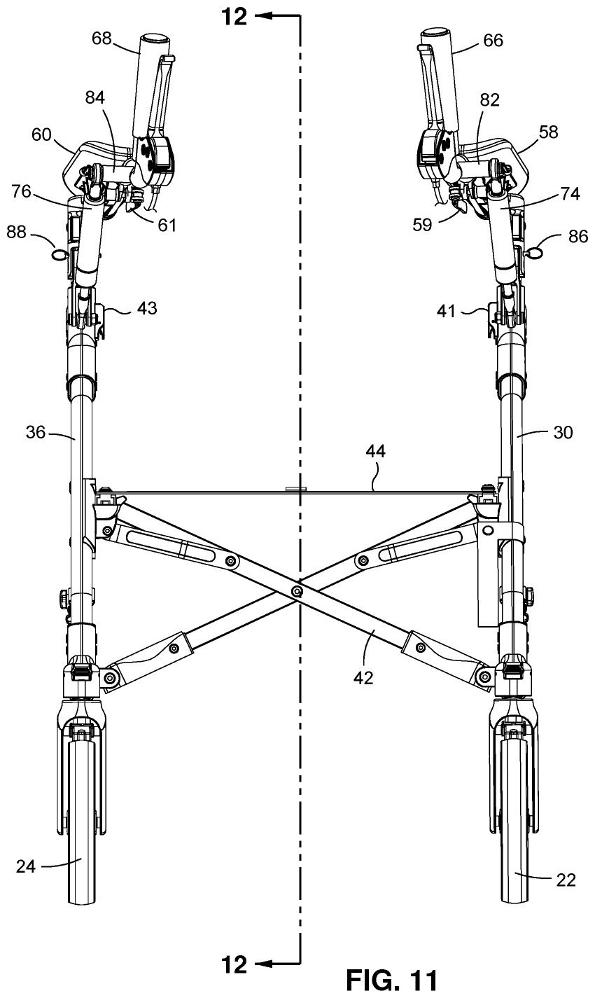

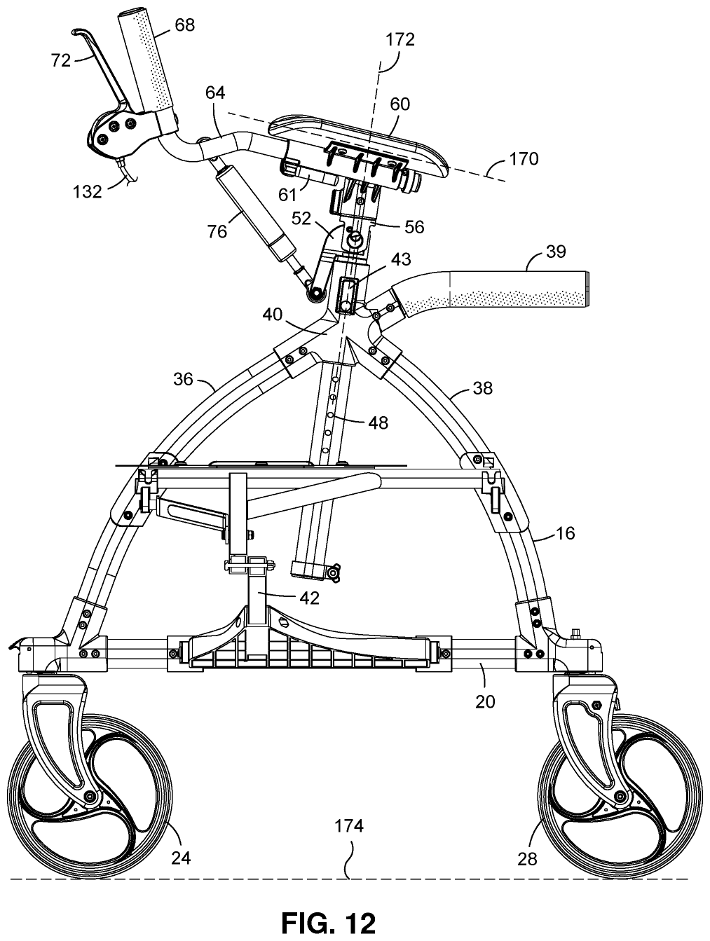

FIG. 10 is a top view of the disclosed device 12. FIG. 11 is a front view of the disclosed device 12. FIGS. 10 and 11 are useful to illustrate that the dampers 74 and 76 are positioned adjacent the handle support members 62 and 64 so as to not interfere with the folding of the device 12. As such the device 12, is collapsible to a folded configuration and the dampers 74 and 76 along with respective attachment members 82 and 84 do not extend outwardly beyond the frames 31 and 39 and do not extend inwardly beyond the handles 66 and 68, and forearm supports 58 and 60 so as to not interfere with the folding action of the device 12. Broken lines 168 and 170 show a longitudinal axis extending through a forward midpoint and rearward midpoint on both forearm supports 168 and 170. FIG. 12 is a cross sectional view along lines 12-12 as shown in FIG. 11. As a cross-sectional view, FIG. 12 is useful to illustrate wheels or wheel assemblies 24 and 28 that are rotatably coupled to base member 20 and support members 36 and 38 extend upwardly from the base member 20, all being part of frame 16. Likewise, as shown in other drawings, such as FIG. 2, wheels or wheel assemblies 22 and 26 are rotatably coupled to base member 18 and support members 30 and 32 extend upwardly from the base member 18, all being part of frame 14. Referring again to FIG. 12, the height adjustment member 48 is coupled to the support members 36 and 38. FIG. 12 also illustrates forearm support 60 longitudinal axis along broken line 170 relative to a broken line 172 demonstrating an axis along the height adjustment member 48. As can be appreciated, as demonstrated in FIGS. 5 and 6 (on the opposite frame showing forearm support 58) the angle between a longitudinal axis along support 58 and height adjustment member 46 will change to at least a first position and second position as the forearm support 58 moves about a point of rotation such as the hinge assembly 50 which is a pivotal connection between the adjustable support member 46 and the forearm support 58. Likewise the angle between the longitudinal axis 170 of forearm support member 60 and an axis through adjustable support member 48 will change to at least a first position and second position as the forearm support 60 moves about a point of rotation such as the hinge assembly 52 which is a pivotal connection between the adjustable support member 48 and the forearm support 60. Also, the angle between longitudinal axis 170 and the walking surface 174 (shown in broken lines) will change as the forearm support 60 moves from a first and second position, as shown, for example in FIGS. 5 and 6. It is understood that the range of motion of forearm supports 58 and 60 may be limited by the full extension or full compression of the dampers 74 and 76, but that full range of motion is not required for use, as the user may move the forearm supports 58 and 60 in ranges that do not reach the full extension of full compression of the dampers 74 and 76. Also, the range of motion may be limited by mechanical limitations of the length of the dampers 74 and 76, irrespective whether the dampers reach full compression or full extension. Again, a user may move the forearm supports 58 and 60 in ranges that are less than the full mechanical range as may be limited by the length of the dampers 74 and 76 or other mechanical components.

The above description is given by way of example, and not limitation. Given the above disclosure, one skilled in the art could devise variations that are within the scope and spirit of the device disclosed herein, including structures, assemblies and way of fabricating the disclosed wheeled walker. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A wheeled walker device comprising:
a first side frame and a second side frame, each side frame comprising:
a plurality of wheel assemblies;
an elongate base member coupled to the plurality of wheel assemblies; and
at least one support member coupled to and extending upwardly from the base member;
a first height adjustment member adjustably coupled to the at least one support member of the first side frame;
a second height adjustment member adjustably coupled to the at least one support member of the second side frame;
a first forearm support having a forward point and a rearward point defining a longitudinal axis along the first forearm support between the forward and rearward points, the first forearm support pivotally coupled to the first height adjustment member, the first high adjustment member defining a first member axis along the length of the height adjustment member, wherein the first forearm support is rotatable from a first position defining a first angle between the longitudinal axis of the first forearm support and the first member axis of first height adjustment member to a second position defining a second angle between the longitudinal axis of the first forearm support and the first member axis of first height adjustment member; and
a second forearm support having a forward point and a rearward point defining a longitudinal axis along the second forearm support between the forward and rearward points, the second forearm support pivotally coupled to the second height adjustment member, the second height adjustment member defining a second member axis along the length of the height adjustable member, wherein the second forearm support is rotatable from a first position defining a first angle between the longitudinal axis of the second forearm support and the second member axis of the second height adjustment member to a second position defining a second angle between the longitudinal axis of the second forearm support and the second member axis of the second height adjustment member.

2. The wheeled walker device of claim 1 wherein the first forearm support is coupled to a first elongate handle member and the second forearm support is coupled to a second elongate handle member.

3. The wheeled walker of claim 2 further comprising:
a first elongate damper having first and second ends, the first end of the first damper pivotally coupled the first handle member and the second end of the first damper pivotally coupled to the first height adjustment member; and
a second elongate damper having first and second ends, the first end of the second damper pivotally coupled the second handle member and the second end of the second damper pivotally coupled to the second height adjustment member.

4. The wheeled walker of claim 3 wherein the damper is a twin tube damper.

5. The wheeled walker of claim 3 wherein the damper is speed sensitive.

6. The wheeled walker of claim 1 wherein the first forearm support is pivotably connected to the first height adjustment member via a first joint having a lower joint portion for coupling to the first height adjustment member and an upper joint portion for coupling to the first forearm support, the upper joint portion movable about a pivot interconnecting the lower joint portion to the upper joint portion; and wherein the second forearm support is pivotally connected to the second height adjustment member via a second joint having a lower joint portion for coupling to the second height adjustment member and an upper joint portion for coupling to the second forearm support, the upper joint portion movable about a pivot interconnecting the lower joint portion to the upper joint portion.

7. The wheeled walker of claim 6 wherein the pivot comprises at least first and second apertures to define an open channel through the pivot.

8. The wheeled walker of claim 6 wherein the pivot comprises first and second ends, wherein each of said first and second ends provides an offset recess and retaining fasteners positioned to maintain an orientation of the pivot.

9. The wheeled walker of claim 1 further comprising at least one member for interconnecting the first and second side frames.

10. The wheeled walker of claim 5 wherein the at least one member is an X-folder apparatus.

11. The wheeled walker of claim 6 wherein the first forearm support is coupled to a first elongate handle member and the second forearm support is coupled to a second elongate handle member.

12. The wheeled walker of claim 11 further comprising an attachment member extending from the lower joint portions of the first and second joints.

13. The wheeled walker of claim 12 further comprising:
a first elongate damper having first and second ends, the first end of the first damper pivotally coupled the first handle member and the second end of the first damper pivotally coupled to the attachment member of the lower portion of the first joint; and
a second elongate damper having first and second ends, the first end of the second damper pivotally coupled the second handle member and the second end of the second damper pivotally coupled to the attachment member of the lower portion of the second joint.

14. A wheeled walker device comprising:
a first side frame and a second side frame, each side frame comprising:
a plurality of wheel assemblies;
an elongate base member coupled to the plurality of wheel assemblies; and
at least one support member coupled to and extending upwardly from the base member;
a first height adjustment member adjustably coupled to the at least one support member of the first side frame;
a second height adjustment member adjustably coupled to the at least one support member of the second side frame;
a first forearm support coupled to a first elongate handle member;
a second forearm support coupled to a second elongate handle member;
a first joint having a lower joint portion for coupling to the first height adjustment member and an upper joint portion for coupling to the first forearm support, the upper joint portion movable about a pivot interconnecting the lower joint portion to the upper joint portion; and
a second joint having a lower joint portion for coupling to the second height adjustment member and an upper joint portion for coupling to the second forearm support, the upper joint portion movable about a pivot interconnecting the lower joint portion to the upper joint portion.

15. The wheeled walker of claim 14 further comprising:
a first elongate damper having first and second ends, the first end of the first damper pivotally coupled the first handle member and the second end of the first damper pivotally coupled to the lower joint portion of the first joint; and
a second elongate damper having first and second ends, the first end of the second damper pivotally coupled the second handle member and the second end of the second damper pivotally coupled to the lower joint portion of the second joint.

16. The wheeled walker of claim 14 further comprising at least one member for interconnecting the first and second side frames.

17. The wheeled walker of claim 16 wherein the at least one member comprises an X-folder apparatus.

18. A wheeled walker comprising:
a first side frame and a second side frame, each side frame comprising:
a plurality of wheel assemblies;
an elongate base member coupled to the plurality of wheel assemblies; and
at least one support member coupled to and extending upwardly from the base member;
a first user support pivotally coupled to the at least one support member of the first frame, wherein the first user support is rotatable from a first position defining a first angle relative to a walking surface to a second position defining a second angle relative to a walking surface;
a second user support pivotally coupled to the at least one support member of the second frame, wherein the second user support is rotatable from a first position defining a first angle relative to a walking surface to a second position defining a second angle relative to a walking surface;
a first elongate damper having first and second ends, the first end of the first damper pivotally coupled the first user support and the second end of the first damper pivotally coupled to the support member of the first frame; and
a second elongate damper having first and second ends, the first end of the second damper pivotally coupled the second user support and the second end of the second damper pivotally coupled to the support member of the second frame.

19. The wheeled walker of claim 18 wherein the first side frame is interconnected to the second side frame via an X-folder apparatus.

20. The wheeled walker of claim 18 wherein the damper is a twin tube damper.

21. The wheeled walker of claim 18 wherein the first user support is pivotably connected to the support member of the first frame via a first joint having a lower joint portion for coupling to the support member of the first frame and an upper joint portion for coupling to the first user support, the upper joint portion movable about a pivot interconnecting the lower joint portion to the upper joint portion and wherein the second user support is pivotably connected to the support member of the second frame via a second joint having a lower joint portion for coupling to the support member of the second frame and an upper joint portion for coupling to the second user support, the upper joint portion movable about a pivot interconnecting the lower joint portion to the upper joint portion.

22. The wheeled walker of claim 21 wherein the second ends of the first and second dampers are attached to attachment members protruding from the lower joint portions of the first and second joints.
